(19) United States
(12) Patent Application Publication
(10) Pub. No.: US 2013/0049690 A1
(43) Pub. Date: Feb. 28, 2013

(54) Vehicle Charger with Memory Function for Electric Vehicles

(71) Applicant: Zhenghao Lin, Guangdong (CN)

(72) Inventor: Zhenghao Lin, Guangdong (CN)

(73) Assignee: Dai Chong Wong, N.T. (HK)

(21) Appl. No.: 13/696,361

(22) PCT Filed: Jul. 7, 2010
(86) PCT No.: PCT/CN2010/075037

§ 371 Date: Nov. 6, 2012

(30) Foreign Application Priority Data
May 6, 2010 (CN) 201010169588.5

(51) Int. Cl. H02J 7/00

(52) U.S. Cl. 320/109

(57) ABSTRACT

A vehicle charger with memory function for electric vehicles contains an AC input circuit, a power factor correction circuit, a high voltage DC circuit, a DC-DC conversion circuit, an output control circuit, and a charging output terminal. The charging output terminal is connected to and charges a battery pack of the electric vehicle. A MCU chip, a battery pack voltage detection circuit, an operation data memory chip, a vehicle control signal connection port, a perpetual calendar chip, a data reading port, and an auxiliary power supply circuit are further included. The MCU chip detects a voltage of the battery pack through the battery pack voltage detection circuit, automatically records the charge and discharge data of the battery pack, and stores the data into the operation data memory chip. The recorded data include: times to complete a normal charge process, times and when the charge is not done in time after discharged, times and when the charge is powered off to be stopped before it is full-charged, and times and when the voltage of the battery pack meets a low voltage protection. The charger can provide real-time and reliable data and has a protection function for batteries with low voltage.

### FIELD OF THE INVENTION

The present invention relates to a charger, and more particularly to a vehicle charger for vehicles, such as electric forklifts, golf carts, sightseeing cars and electric vehicles.

### BACKGROUND OF THE INVENTION

a) A conventional charger in the market can only display the battery pack immediately, but cannot provide a charge reminder as the power is not enough. Besides, after the charge, the charge data cannot be recorded.

b) In the charge of electric vehicles, the charge data cannot be recorded. So as the battery is not charged fully or in a lower voltage, its service life is decreased. In addition, in maintenance, the charge record can not be provided to the maintenance personnel.

c). The conventional charger does not have a perpetual calendar chip to memorize times and when charger and the battery pack is operated.

d). The conventional charger can not charge the battery pack automatically in a balanced charge mode.

The present invention has arisen to mitigate and/or obviate the afore-described disadvantages.

### SUMMARY OF THE INVENTION

The primary object of the present invention is to provide a vehicle charger with memory function for electric vehicles which is used for at least 3 years, so in maintenance, the computer is connected with the charger so as to read operation data stored in chip; and after charging the electric vehicle in a period of time, the battery pack charged automatically, so as to balance parameters of the battery pack.

To obtain the above objective, a vehicle charger with memory function for electric vehicles provided by the present invention contains:

an AC input circuit, a power factor correction circuit, a high voltage DC circuit, a DC-DC conversion circuit, an output control circuit, and a charging output terminal, an output end of the AC input circuit being in connection with an input end of the power factor correction circuit, an output end of the power factor correction circuit coupling with an input end of the high voltage DC circuit, an output end of the high voltage DC circuit connecting with an input end of the DC-DC conversion circuit, an output end of the DC-DC conversion circuit being in connection with an input end of the output control circuit, an output end of the output control circuit coupling with the charging output terminal, and the charging output terminal being connected to and charging a battery pack of an electric vehicle, characterized in that the vehicle charger also comprises: a MCU chip, a battery pack voltage detection circuit, an operation data memory chip, a vehicle control signal connection port, a perpetual calendar chip, a data reading port, and an auxiliary power supply circuit;

the battery pack voltage detection circuit connects with the charging output terminal and the MCU chip, the operation data memory chip couples with the MCU chip so as to store the data from the MCU chip and to output operating data to the MCU chip; the vehicle control signal connection port is in connection with the MCU chip so as to acquire the data from the MCU chip; the perpetual calendar chip couples with the MCU chip; the data reading port is in connection with the MCU chip so that the data reading port and the MCU chip interact with each other, wherein the data reading port reads desired data from the MCU chip; an input end of the auxiliary power supply circuit couples with the output end of the high voltage DC circuit so as to supply power to the DC-DC conversion circuit, the output control circuit, the MCU chip, and the operation data memory chip; the auxiliary power supply circuit is also in connection with the vehicle control signal connection port; the MCU chip detects a voltage of the battery pack through the battery pack voltage detection circuit, automatically records a charge and a discharge data of the battery pack, and stores the data into the operation data memory chip; recorded data include: 1) times to complete a normal charge process, 2) times and when the charge is not done in time after discharged, 3) times and when the charge is powered off to be stopped before it is full-charged, and 4) times and when the voltage of the battery pack meets a low voltage protection.

Preferably, when reading stored data in the changer, a computer is connected to the data reading port through a cable so as to acquire all stored records or partial stored records based on using requirement.

Preferably, the MCU chip automatically charges the battery pack in a balanced charging mode and restores an imbalance among cells of batteries of the battery pack through stored data in the operation data memory chip after the charge and the discharge of the battery pack.

Preferably, the MCU chip detects the voltage of the battery pack through the battery pack voltage detection circuit so that the charger provides a discharge protection function for the batteries. For example, when the voltage of the battery pack lowers to a certain value and lasts a period of time, the MCU chip transmits a signal to lower a speed of a vehicle, and when the voltage of the battery pack further lowers to a lower voltage, the MCU chip transmits another signal to stop the vehicle, thus protecting the battery pack and preventing the battery pack from an overdischarge.

Thereby, the recorded data including, times to complete a normal charge process, times and when the charge is not done in time after discharged, times and when the charge is powered off to be stopped before it is full-charged, and times and when the voltage of the battery pack meets a low voltage protection, are recorded so as to provide using data to maintenance companies.

The MCU chip automatically charges the battery pack in the balanced charging mode.

When the voltage of the battery pack lowers to a certain value and lasts a period of time, the MCU chip transmits a signal to lower a speed of a vehicle, and when the voltage of the battery pack further lowers to a lower voltage, the MCU chip transmits another signal to stop the vehicle, thus protecting the battery pack and preventing the battery pack from an overdischarge.

The vehicle charger is used in vehicles, such as electric forklifts, golf carts, sightseeing cars and electric vehicles.

### BRIEF DESCRIPTION OF THE DRAWINGS

FIG. 1 is a schematic diagram of a vehicle charger with memory function for electric vehicles according to the present invention.

### DETAILED DESCRIPTION OF THE PREFERRED EMBODIMENTS

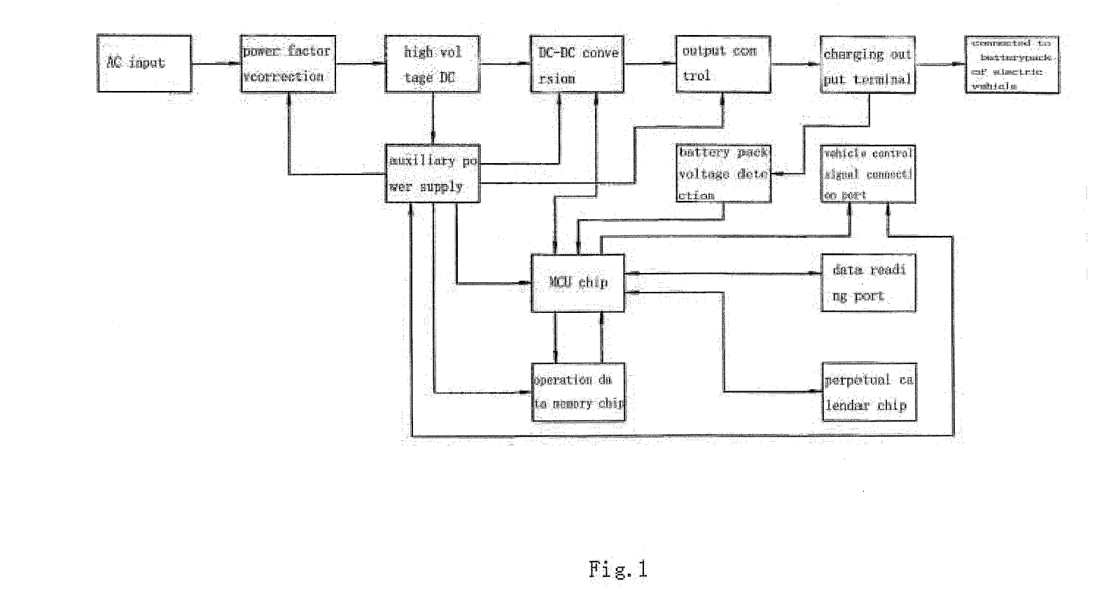

With reference to FIG. 1, a vehicle charger with memory function for electric vehicles according to the present invention comprises: an AC input circuit, a power factor correction circuit, a high voltage DC circuit, a DC-DC conversion circuit, an output control circuit, and a charging output terminal. An output end of the AC input circuit is in connection with an input end of the power factor correction circuit, an output end of the power factor correction circuit couples with an input end of the high voltage DC circuit, an output end of the high voltage DC circuit connects with an input end of the DC-DC conversion circuit, an output end of the DC-DC conversion circuit is in connection with an input end of the output control circuit, an output end of the output control circuit couples with the charging output terminal, and the charging output terminal is connected to and charges a battery pack of the electric vehicle. The vehicle charger of the present invention also comprises: a MCU chip, a battery pack voltage detection circuit, an operation data memory chip, a vehicle control signal connection port, a perpetual calendar chip, a data reading port, and an auxiliary power supply circuit. The battery pack voltage detection circuit connects with the charging output terminal and the MCU chip so as to acquire data from the charging output terminal and then to login the data into the MCU chip. The operation data memory chip couples with the MCU chip so as to store the data from the MCU chip and to output operating data to the MCU chip. The vehicle control signal connection port is in connection with the MCU chip so as to acquire the data from the MCU chip. The perpetual calendar chip couples with the MCU chip. The data reading port is in connection with the MCU chip so that the data reading port and the MCU chip interact with each other. i.e., the data reading port reads desired data from the MCU chip. An input end of the auxiliary power supply circuit couples with the output end of the high voltage DC circuit so as to supply power to the DC-DC conversion circuit, the output control circuit, the MCU chip, and the operation data memory chip. The auxiliary power supply circuit is also in connection with the vehicle control signal connection port. The MCU chip detects a voltage of the battery pack through the battery pack voltage detection circuit, automatically records the charge and discharge data of the battery pack, and stores the data into the operation data memory chip. The recorded data include: 1) times to complete a normal charge process, 2) times and when the charge is not done in time after discharged, 3) times and when the charge is powered off to be stopped before it is full-charged, and 4) times and when the voltage of the battery pack meets a low voltage protection. When reading stored data in the changer, a computer is connected to the data reading port through a cable so as to acquire all stored records or partial stored records based on using requirement.

The MCU chip automatically charges the battery pack in a balanced charging mode and restores an imbalance among cells of batteries of the battery pack through stored data in the operation data memory chip after a charge and discharge of the battery pack.

The MCU chip detects the voltage of the battery pack through the battery pack voltage detection circuit so that the charger provides a discharge protection function for the batteries. For example, when the voltage of the battery pack lowers to a certain value (such as 1.8V/cell) and lasts a period of time (such as 10 seconds), the MCU chip transmits a signal to lower a speed of a vehicle, and when the voltage of the battery pack further lowers to a lower voltage (such as 1.7V/cell), the MCU chip transmits another signal to stop the vehicle, thus protecting the battery pack and preventing the battery pack from an overdischarge. The perpetual calendar chip and the operation data memory chip are used to check the time as the charger is about to be delivered from the factory, such that the operation dates and times of the battery pack and the charger are recorded accurately.

In detail, the operation processes of the charger include:

A. when the AC input circuit of the charger couples with a mains electricity so as to charge the batteries of the battery pack, the auxiliary power supply circuit controls partial power supply, the MCU chip communicates with the perpetual calendar chip so as to obtain an occurrence time in each event. In addition, the MCU chip detects whether the charging output terminal is connected to the battery pack of the electric vehicle and checks if the voltage of the battery pack is normal, wherein if the charging output terminal is not connected to the battery pack of the electric vehicle or the voltage of the battery pack is abnormal, the charger is powered off. If the charging output terminal is connected to the battery pack, the MCU chip controls and detects the charge of the battery pack based on a set program as delivering the charger. If the battery pack is fully charged, the MCU records the charge data of the battery pack into the operation data memory chip.

B. When the times to complete the normal charge process reaches a certain number (such as 30 times), the MCU chip operates in the balanced charging mode and automatically restores the imbalance among cells of the battery pack.

C. When the charge is powered off to be stopped before it is full-charged, the MCU chip records the times and when the charge is not done in time after discharged

D. When the charger is not connected with the mains electricity and an ignition switch of the electric vehicle is not started, the charger is in an off state. In the meantime, the charger does not consume the energy of the batteries and does not detect the voltage of the battery pack. But the batteries of the battery pack supply power to the perpetual calendar chip so that the perpetual calendar chip operates continuously, thus preventing the batteries from damage because of the discharge after the charger is coupled with the electric vehicle. Once the ignition switch ignites, the auxiliary power supply circuit gets the power from the battery pack and transforms the power to the output control circuit. After the MCU chip powers on, the battery pack voltage detection circuit detects the voltage of the battery pack, and when the voltage of the battery pack lowers to the certain value (such as 1.8V/cell) and lasts a period of time (such as 60 seconds), the MCU chip records an occurrence time of a voltage of the next pack and the voltage of the next battery pack and transmits a signal to a controller of the electric vehicle so that the electric vehicle lowers its speed.

Thereafter, when the voltage of the next pack lowers to another lower voltage (such as 1.7V/ceel) and lasts a period of time (such as 30 seconds), the MCU chip records an instant voltage and an occurrence time of the instant voltage and transmits another signal to power off the controller, thus stopping the electric vehicle.

Because the charger comprises the perpetual calendar chip, the operation data memory chip, the vehicle control signal connection port, and data reading port, the charger is set date and time in delivery time (of Beijing), and then when the MCU chip detects the following data, it records the following data in the operation data memory chip. These data include: times to complete a normal charge process, times and when the charge is not done in time after discharged, times and when the charge is powered off to be stopped before it is full-charged, and times and when the voltage of the battery pack meets a low voltage protection. The charger can provide real-time and reliable data and has a protection function for batteries with low voltage.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A vehicle charger with memory function for electric vehicles comprising:
an AC input circuit, a power factor correction circuit, a high voltage DC circuit, a DC-DC conversion circuit, an output control circuit, and a charging output terminal, an output end of the AC input circuit being in connection with an input end of the power factor correction circuit, an output end of the power factor correction circuit coupling with an input end of the high voltage DC circuit, an output end of the high voltage DC circuit connecting with an input end of the DC-DC conversion circuit, an output end of the DC-DC conversion circuit being in connection with an input end of the output control circuit, an output end of the output control circuit coupling with the charging output terminal, and the charging output terminal being connected to and charging a battery pack of an electric vehicle, characterized in that the vehicle charger also comprises: a MCU chip, a battery pack voltage detection circuit, an operation data memory chip, a vehicle control signal connection port, a perpetual calendar chip, a data reading port, and an auxiliary power supply circuit;
the battery pack voltage detection circuit connects with the charging output terminal and the MCU chip, the operation data memory chip couples with the MCU chip so as to store the data from the MCU chip and to output operating data to the MCU chip; the vehicle control signal connection port is in connection with the MCU chip so as to acquire the data from the MCU chip; the perpetual calendar chip couples with the MCU chip; the data reading port is in connection with the MCU chip so that the data reading port and the MCU chip interact with each other, wherein the data reading port reads desired data from the MCU chip; an input end of the auxiliary power supply circuit couples with the output end of the high voltage DC circuit so as to supply power to the DC-DC conversion circuit, the output control circuit, the MCU chip, and the operation data memory chip; the auxiliary power supply circuit is also in connection with the vehicle control signal connection port; the MCU chip detects a voltage of the battery pack through the battery pack voltage detection circuit, automatically records a charge and a discharge data of the battery pack, and stores the data into the operation data memory chip; recorded data include: 1) times to complete a normal charge process, 2) times and when the charge is not done in time after discharged, 3) times and when the charge is powered off to be stopped before it is full-charged, and 4) times and when the voltage of the battery pack meets a low voltage protection.

2. The vehicle charger with memory function for the electric vehicles as claimed in claim 1, characterized in that when reading stored data in the changer, a computer is connected to the data reading port through a cable so as to acquire all stored records or partial stored records based on using requirement.

3. The vehicle charger with memory function for the electric vehicles as claimed in claim 1, characterized in that the MCU chip automatically charges the battery pack in a balanced charging mode and restores an imbalance among cells of batteries of the battery pack through stored data in the operation data memory chip after the charge and the discharge of the battery pack.

4. The vehicle charger with memory function for the electric vehicles as claimed in claim 3, characterized in that when the times to complete the normal charge process reaches 30 times, the MCU chip operates in the balanced charging mode.

5. The vehicle charger with memory function for the electric vehicles as claimed in claim 1, characterized in that the MCU chip detects the voltage of the battery pack through the battery pack voltage detection circuit so that the charger provides a discharge protection function for the batteries including, when the voltage of the battery pack lowers to a certain value and lasts a period of time, the MCU chip transmits a signal to lower a speed of the vehicle, and when the voltage of the battery pack further lowers to a lower voltage, the MCU chip transmits another signal to stop the vehicle, thus protecting the battery pack.
